(19) United States
(12) Patent Application Publication
(10) Pub. No.: US 2012/0179486 A1
(43) Pub. Date: Jul. 12, 2012

(54) INDIVIDUALIZED ALLOCATION OF HEALTH RESOURCES

(75) Inventors: Einar Stefansson, Reykjavik (IS); Toke Bek, Risskov (DK); Olafur Palsson, Reykjavik (IS); Stefan Einarsson, Reykjavik (IS); Anna Bryndis Einarsdottir, Reykjavik (IS); Anna Gudmunsdottir, Reykjavik (IS); Thor Aspelund, Reykjavik (IS)

(73) Assignee: RISK, Reykjavik (IS)

(21) Appl. No.: 13/380,777

(22) PCT Filed: Jun. 25, 2010
(86) PCT No.: PCT/IS2010/050005

§ 371 Date: Mar. 12, 2012

(30) Foreign Application Priority Data
Jun. 25, 2009 (IS) 8834

(51) Int. Cl. G06Q 50/22

(52) U.S. Cl. 705/2

(57) ABSTRACT

The present invention discloses methods, computer program and system to overcome the limitation of the current clinical practice. This is achieved by using information technology and the vast amount of epidemiological data available to create algorithms that calculate the risk or severity profile of an individual with any given disease. The individual profile presents the current condition and/or position of the individual in comparison with the mean base curve of the total population and in accordance with upper and lower risk limits. The individual profile is then fitted with its optimal use of healthcare resources, such as medication, surgery, laser treatment, surveillance and follow-up, to optimize and individualize the health outcome of this individual, and at the same time optimize and individualize the allocation of healthcare resources within the system.

### FIELD OF INVENTION

The present invention relates to the field of health care, more specifically to the allocation of health resources.

### BACKGROUND

The current practice in health care in medicine is to allocate healthcare resources i.e. treatment, screening, follow up examinations, based on the grouping of patients into categories. These categories are typically diagnostic categories, i.e. the presence of a certain disease, and sometimes within each disease fairly broad grouping based on severity, typically only a few groups and rarely more than 10. Such grouping is based on tradition and the clinical data available. The ability of health care providers to individualize the evaluation of each patient is limited by the capability, funding, time and human resources of the healthcare providers to compute a detailed risk analysis. It is practical for the individual physician or healthcare provider to categorize a patient into broad categories for which standardized management (treatment, screening, follow up examinations) is prescribed, sometimes supported by large health organization that work on medium standards, such as the World Health Organization. To date no intense efforts have been made to use epidemiological data, outcome research and information technology to compute the exact individualized severity profile for each individual and base the allocation of healthcare resources, i.e. management (treatment, screening, follow up examinations on the individual profile (outcome) as apposed to placing the individual into a broad group with a standardized treatment.

The limitation of current practice in healthcare resource allocation and patient management, is that it must be oriented either at the mean level of severity of each specific group or at the members of the group with the highest severity or risk, which means that within each group of patients some will receive management, treatment or surveillance which is not appropriate for that exact individual, but rather for the average or upper limits of the group, making the patient management less focused, more expensive and less efficient.

### SUMMARY OF THE INVENTION

The present invention overcomes the limitation of current clinical practice by using information technology to calculate on individual basis appropriate allocation of health resources.

In the first aspect the present invention discloses a method for individualized allocation of health resources, for already diagnosed individuals. The method receives data for the desired risk margin and information or risk factor for each individual. Then, for each individual the method calculates the time duration until next screening should take place.

In one aspect the risk factor is adapted to individuals already diagnosed with diabetes and indicates the risk of developing sight threatening retinopathy, is calculated by summing the difference of hemoglobin scaled by first scaling factor and the diastolic blood pressure scaled by second scaling factor and an additive constant.

In one aspect the risk factor is adapted to individuals already diagnosed with diabetes and non proliferative retinopathy which changes the additive constant.

In one aspect the risk factor is adapted to female individuals already diagnosed with diabetes and non proliferative retinopathy which changes the additive constant.

In one aspect the method calculates the time duration until next screening according to the exponential function (100) for individuals already diagnosed with diabetes type 1.

In one aspect the method calculates the time duration until next screening according to the exponential function (101) for individuals already diagnosed with diabetes type 1 and non proliferative retinopathy.

In one aspect the method calculates the time duration until next screening according to the exponential function (102) for individuals already diagnosed with diabetes type 2.

In one aspect the method calculates the time duration until next screening according to the exponential function (103) for individuals already diagnosed with diabetes type 2 and non proliferative retinopathy.

In one aspect the present invention discloses a method for the individualized allocation of health resources. The method comprises providing clinical data for the individual and data for the desired probability of reaching treatment end point within time is provided. The allocation of health resources is determined for the individual by calculating acceptable time duration until next screening based on said data and said probability.

In another aspect the present invention discloses a method to calculate the acceptable time duration until next screening for each individual by solving an equation. The first term of the equation is the difference of constant A and the duration in years of diabetic condition of the individual multiplied by a constant k1. The second term of the equation is the difference of constant B and the percentage of hemoglobin HbAlc in the blood of the individual multiplied the result by a constant k2. The third term of the equation is the difference of constant DBP and the diastolic blood pressure of the individual multiplied by a constant k3. Next, the first, second, and third terms are all added together and one is added to the sum. Finally, the sum is multiplied with a constant k4. The acceptable time duration and constants depend on said data for desired probability of reaching treatment end point within time, and the type of diabetes suffered by the individual.

In another aspect the present invention discloses a method to calculate the acceptable time duration until next screening for each individual by solving an equation. The first term of the equation applies the natural logarithm to the ratio of probability over one less the probability (the odds ratio) and subtracts the result from a constant c1. The second term of the equation applies the natural logarithm to the sum of the number of haemorrhages the individual has suffered and one and the result is multiplied by a constant c2. The third term of the equation is the product of the duration of diabetes of in years and the constant c3. The fourth term is the product of the percentage of hemoglobin hbAlc in the blood of the individual and the constant c4. The fifth term is the product of the diastolic blood pressure of the individual and the constant k5. Finally, the sum of said first, second, third, fourth, and fifth terms is calculated. The acceptable time duration and constants depend on said data for desired probability of reaching treatment end point within time, and the type of diabetes.

In another aspect the present invention discloses a computer program or suite of computer programs so arranged such that when executed on a processor the program or suite of programs cause(s) the processor to perform the methods described above.

In another aspect the present invention discloses a computer readable data storage medium storing the computer program or at least one of the suites of computer programs described above.

In another aspect the present invention discloses a computer program product as described above were the databases reside on the same computer as the computing program product.

In another aspect the present invention discloses computer program products as described above were the databases and the computing program product reside on different computers.

In another aspect the present invention discloses a system for the individualized allocation of health resources. The system is comprised of a processor, a human machine interface capable of receiving and communicating data, a data storage, a computer program or suite of computer programs as described above to execute the methods also described before. The system is adapted to receive data for the desired probability of reaching treatment end point within time, and data regarding said individual condition, to execute the program or suites of programs on the processor to calculate acceptable time duration until next visit based on the data and probability given, and present results of the calculation.

### BRIEF DESCRIPTION OF DRAWINGS

FIG. 1: The prevalence of diabetic macular edema and proliferative diabetic retinopathy over the duration of diabetes mellitus type 1.

FIG. 2: The image demonstrates the prevalence of diabetic macular edema and proliferative diabetic retinopathy diabetes mellitus type 2.

FIG. 3: The individual profile adjusted in accordance with the mean base curve.

FIG. 4: Current allocation scheme, fixed time interval

FIG. 5: Individualized allocation scheme

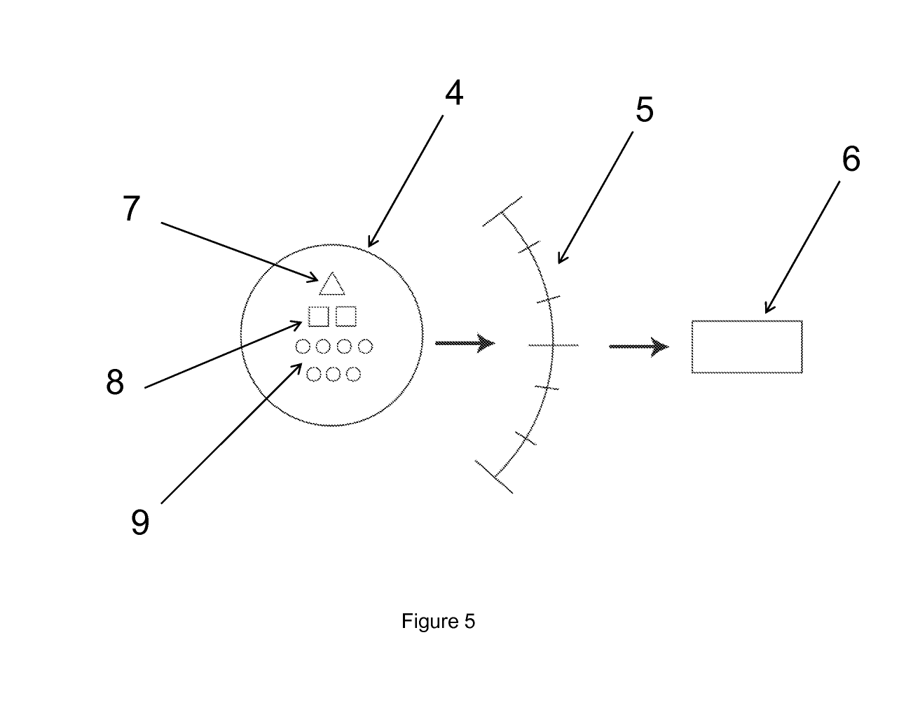

FIG. 6: Equation for Risk Factor

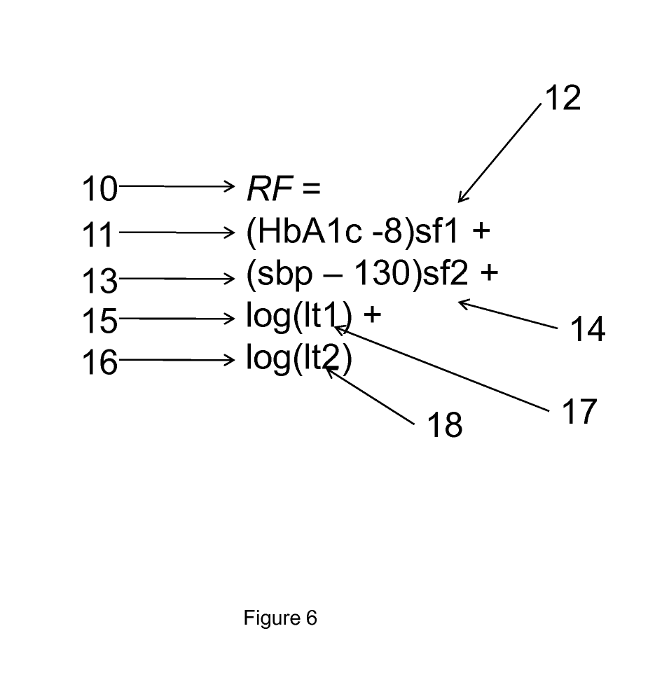

FIG. 7: One possible user interface for the calculator (health resource allocator)

FIG. 8: Exponential function for calculating time interval

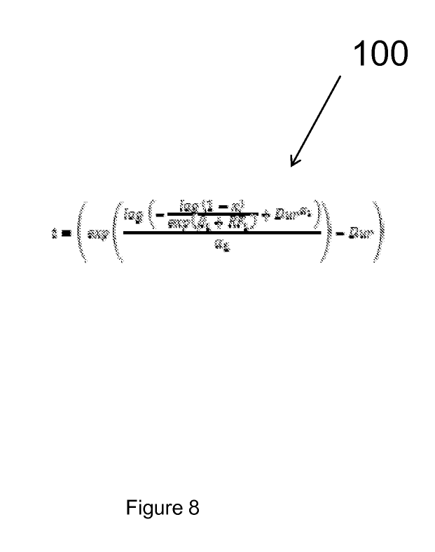

FIG. 9: Exponential function for calculating time interval

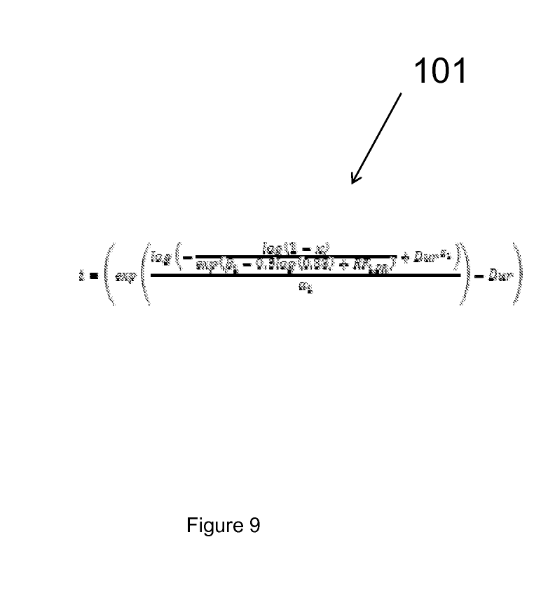

FIG. 10: Exponential function for calculating time interval

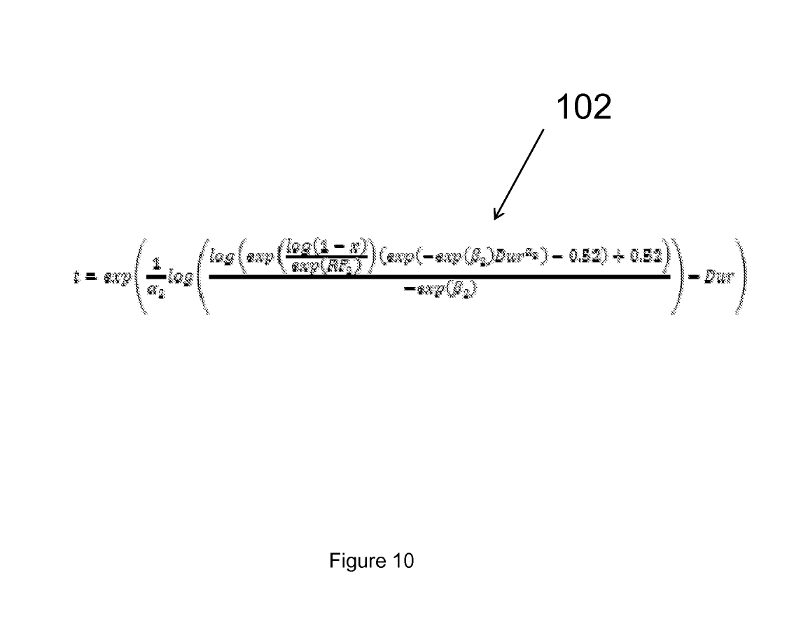

FIG. 11: Exponential function for calculating time interval

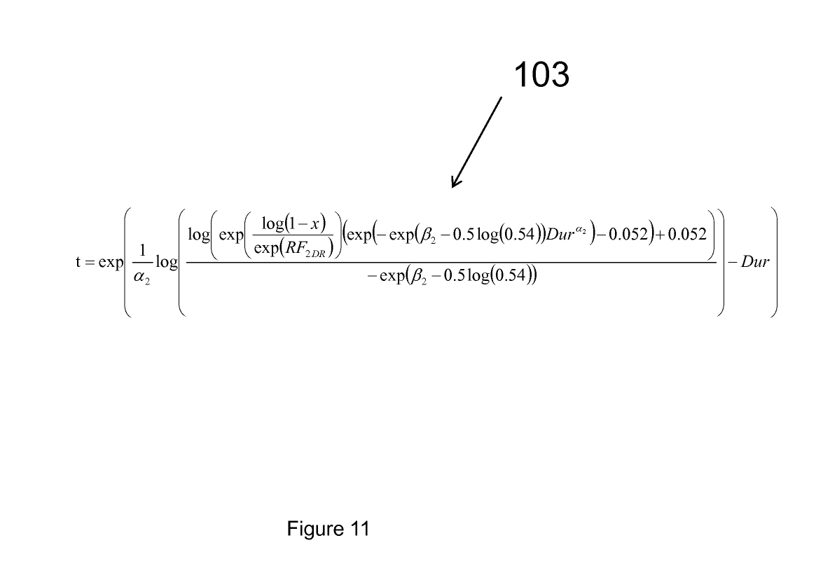

### DETAILED DESCRIPTION

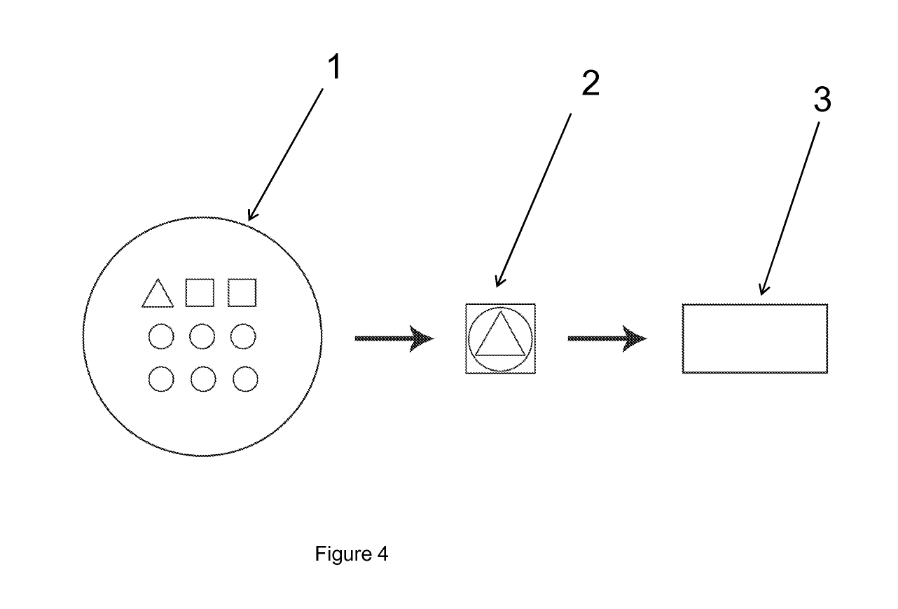

As stated previously, the limitation of current practice in healthcare resource allocation and patient management, is that it must be oriented either at the mean level of severity of each specific group 1 or at the members of the group with the highest severity or risk 7, which means that within each group of patients some will receive treatment or surveillance which is not appropriate for that exact individual, but rather for the average or upper limits of the group. In FIG. 4, the current practice in health care resource allocation is represented by box 3. A group of already diagnosed individuals 1 are allocated health resources 3 according to some group standard 2. Annual examinations are standard in most diabetic eye-screening programs and recommended by the World Health Organization.

With a fixed interval 3 between screening visits, the interval is the same for all 2, whereas the risk of developing sight threatening retinopathy in-between screening visits is individually variable 5. Some patients are at high risk 7 of developing sight threatening retinopathy before the next screening visit, whereas for others this risk would be low 9. The fixed screening interval 3 must be geared towards patients at relatively high risk 7; otherwise they might go blind. The fixed “one size fits all” approach to screening leaves room for optimization. By basing the screening interval on each patient's risk levels 5, it would be possible to increase screening frequency 6 for those at high risk 7 and thereby increase their safety and at the same time reduce the screening frequency 6 in patients at low risk 9 and reduce expenditures in health care costs and patients' time. Indeed, such an approach might apply to a variety of diseases.

Individualized risk estimation is not new. The Icelandic Heart Association's risk calculator estimates the probability of getting coronary heart disease in the next 10 years. The risk estimate is based on data that the Icelandic Heart Association has collected over the past 40 years. The risk calculator is comparable to the European risk calculator (SCORE, European Society of Cardiology). A measurement that gives a low risk in the calculator, does not guarantee the user a low risk of getting a coronary heart disease since the risk estimate is only based on risk factors known today. The SCORE risk assessment is derived from a large dataset of prospective European studies and predicts fatal atherosclerotic CVD events over a ten year period. This risk estimation is based on the following risk factors: gender, age, smoking, systolic blood pressure and total cholesterol. The threshold for high risk based on fatal cardiovascular events is defined as “higher than 5%”, instead of the previous “higher than 20%” using a composite coronary endpoint. This SCORE model has been calibrated according to each European country's mortality statistics. In other words, if used on the entire population aged 40-65, it will predict the exact number of fatal CVD-events that eventually will occur after 10 years.

The FRAX tool has been developed by the WHO to evaluate fracture risk of patients. It is based on individual patient models that integrate the risks associated with clinical risk factors as well as bone mineral density (BMD) at the femoral neck. The FRAX models have been developed from studying population-based cohorts from Europe, North America, Asia and Australia. In their most sophisticated form, the FRAX tool is computer-driven and is available on the web. The FRAX algorithms give the 10-year probability of fracture. The output is a 10-year probability of hip fracture and the 10-year probability of a major osteoporosis fracture (clinical spine, forearm, hip or shoulder fracture)

Common to the available risk assessment tools is the fact that they consider the risk factors known to influence the condition of the patient over fixed time and calculate the risk of developing the disease or condition.

General form of the functions used to calculate the risk is as follows where one of the exponential functions is based on the fixed time.

Risk=c₁*e^{var1}+c₂*e^{var2}+ . . . +cₙ*e^{Time}+factor

The variables in the exponents and the number of exponent functions vary depending on the disease and the additive factor, if used, is based on the initial condition of the disease.

The present invention takes the concept calculating risk further and can effectively be applied to any risk model currently available within clinical medicine, the health industry or that is developed for health purposes. The present invention discloses a method and system for the individual allocation of health resources. The implementations of the invention which are described in the following text vary according to disease category, major stakeholders of health resources within each applied health system and the political and social scheme structured around current group allocations of health resources. Such variations are not to be regarded as a deviation or departure from the spirit and scope of the present invention, and all such modifications as would be obvious to one skilled in the art are intended to be included within the scope of the following claims

The following embodiments describe the application of the present invention for patients with diabetes. Diabetic retinopathy (DR) is in many countries amongst the most common causes of working age people loosing eyesight as well as being the second or third most common cause of blindness over all. Studies have shown that, higher HbAlc, longer duration of diabetes, higher blood pressure, higher total triglycerides and total-to-HDL cholesterol and lower HDL cholesterol increases the risk for diabetic retinopathy in patients with diabetes.

One example is the screening for diabetic eye diseases where typically all patients with diabetes are screened for eye disease once a year. This frequency (once a year) is recommended by the WHO and is consistent with successfully reducing the prevalence of diabetic blindness. According to literature, leading experts opinions and epidemiological data this frequency of screening is adequate for members of the diabetic population who are at a high risk for developing eye diseases but excessive for those with low risk. Subsequently the recommended interval would serve in many cases as a save upper (max. visits) risk limit. This means that a large portion of the group is undergoing eye examinations unnecessarily frequently creating an inconvenience for the patient and considerable costs for the individuals, health authorities and any other stakeholder. By creating an individualized risk profile for each patient based on epidemiological data such as duration of diabetes, blood glucose, blood pressure etc., the screening frequency can be reduced from the annual visit to one visit every 2-5 years within an overall decrease of visits to one half to one third of what is currently standard. This can be achieved without sacrificing any security simply by individualizing the risk profile and allocating the healthcare resources, in this case screening examinations, accordingly.

The method is based on one hand in developing algorithms derived from data banks, and on the other hand on epidemiological information showing the prevalence of sight threatening diabetic retinopathy, that is diabetic macular edema and proliferative diabetic retinopathy over the duration of diabetes in type 1 and type 2 diabetes mellitus.

Epidemiological information available in scientific literature shows the effect of blood glucose, hemoglobin Alc and blood pressure on the risk of sight threatening retinopathy and these are used to multiply the base curves of retinopathy prevalence according to the clinical data for each patient, that is the type of diabetes, duration of diabetes, haemoglobin Alc levels, blood pressure levels and other minor clinical data basis

In the following embodiment of the present invention a risk analysis algorithms which can be implemented as a computer program is created. The computer program can be executed on a processor implementing the steps of the algorithms. The algorithm evaluates the risk for developing micro vascular complications for those who have diabetes mellitus (DM). The algorithms calculates the risk for eye disease, so called diabetic retinopathy, which is one of the leading causes of blindness in the world.

A detailed search of bibliographic databases (Medline) has identified the following risk factors that may be used for creating the algorithm. Longitudinal and cross sectional data was gathered which involved risk evaluation in relation to retinopathy outcome.

The duration of diabetes needs to be taken into account. The Wisconsin study presented in a multivariate analyses that duration of diabetes (OR 0.75 per 10 years of diabetes) is a significant predictor for progression of retinopathy. Persons with 10 or more years of diabetes at baseline were 1.97 (95% CI 1.56-2.50) and 1.33 (95% CI 0.99-1.79) times as likely to have proliferative retinopathy and macular edema develop over the 14 years of follow-up, respectively, as those with fewer than 10 years duration of diabetes at baseline. Our data base and publications show a similar correlation between duration of diabetes and the prevalence of the various forms of diabetic retinopathy including the sight threatening forms, diabetic macular edema and proliferate diabetic retinopathy.

The metabolic control (measured as blood glucose control with the HbAlc test; or average serum glucose levels) has been shown in large cohort studies to be one of the main risk factors for retinopathy. The DCCT research group showed that using intensive treatment in diabetic type 1 patients (IDDM) with the goal of maintaining blood glucose concentrations close to the normal range decreased the frequency and severity of retinopathy. In the study the mean blood glucose in the intensive therapy was 8.6 mmol/L and in the conventional therapy was 12.8 mmol/L (P<0.001). Median HbAlc in intensive therapy was 7.3% and 9.1% in the conventional therapy. Intensive therapy reduced the adjusted mean risk for the development of retinopathy by 76 percent as compared with conventional therapy. Similar results have been shown for type 2 diabetes in the UKPDS trial. After the end of the DCCT clinical trial all participants were encouraged to use intensive therapy. Within a year from the end of the DCCT the observational phase of the DCCT/EDIC commenced. The rates of prevalence of various levels of retinopathy were significantly lower in the former intensive therapy group than in the former conventional therapy group during year 4 of the EDIC study.

The type of diabetes is relevant as type 1 DM is frequently diagnosed at a young age and patients will live with the disease for decades before the eye complications start to have an effect. Also the prevalence of diabetic retinopathy including the sight threatening forms, diabetic macular edema and proliferative diabetic retinopathy versus duration of diabetes curves are different for type 1 and 2 diabetes.

Conventional risk factors for atherosclerosis and vascular disease, blood pressure, cholesterol and smoking are also taken into account. Studies have shown that LDL cholesterol and total-to-HDL cholesterol increase the incidence of clinically significant macular edema. The UKPDS38 showed that tight blood pressure control reduces the risk of retinopathy in patients with type II diabetes. The Wisconsin study showed that for persons 18 years of age or older, for every 10 pack-years smoked after the diagnosis of diabetes the risk of retinopathy progression decreased by 20% and the risk of progression to proliferative retinopathy decreased by 21%. UKPDS 50 (type 2 DM) showed that those who smoked were less likely to develop retinopathy compared to those that didn't smoke a 37% relative risk reduction.

Progression to proliferative retinopathy and incidence of macular edema were significantly related (P<0.001) to greater severity of retinopathy at baseline in the Wisconsin study.

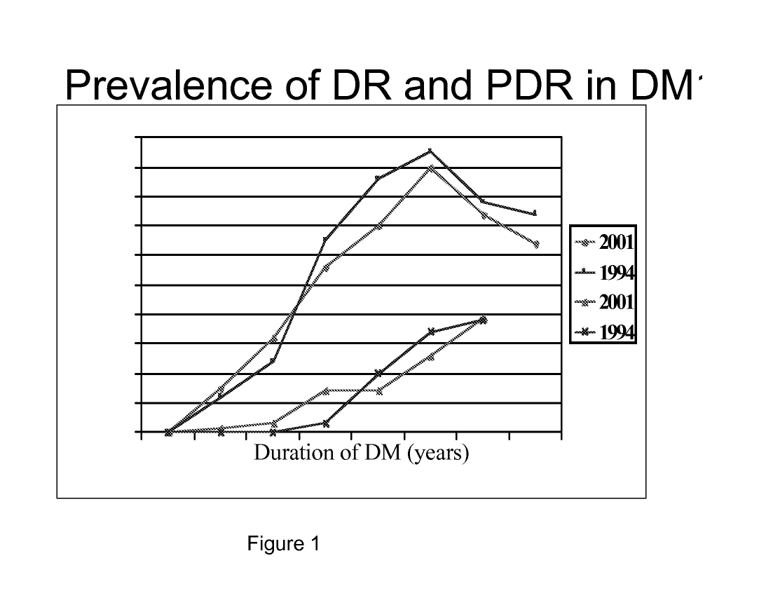

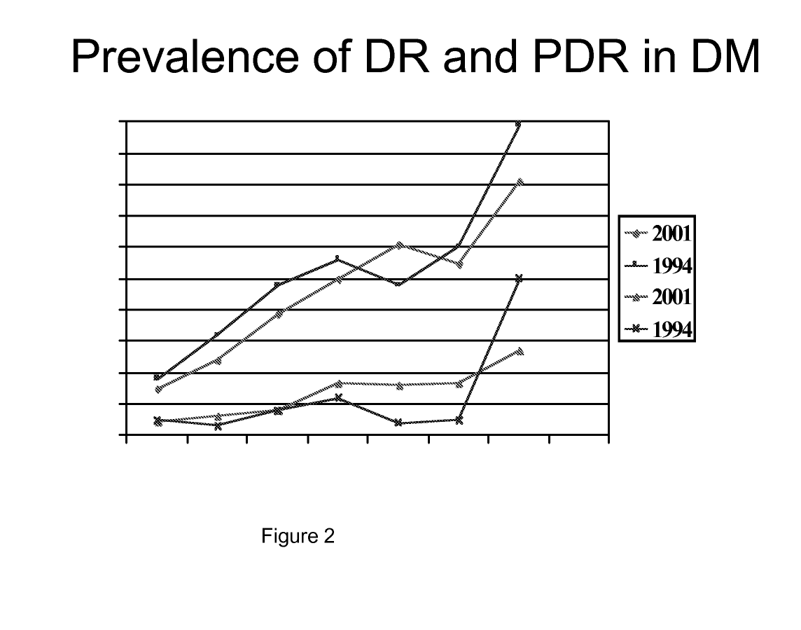

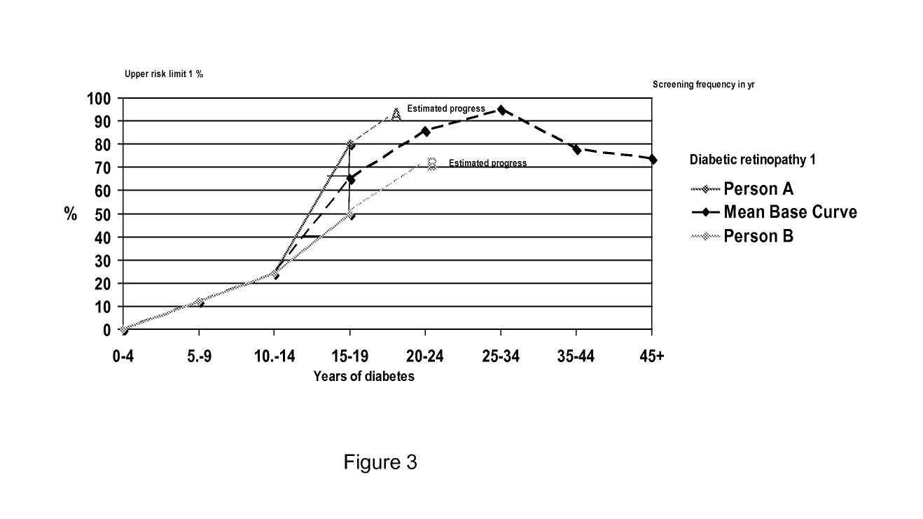

The given variables stated above are risk factors known to influence the development of eye diseases amongst the diabetic population. The epidemiological data that has been gathered about the impact of these variables independently and combined give a representative sample of the mean parameters of the total population. These parameters are used to set upper and lower risk limits that constitute as acceptable risk variances/standards or around 1% or less. From this information a graph is constructed (see FIG. 1-2) that serves as the (mean) base curve for the total population and is used for individual profile comparison. The deviation of an individual risk profile from the mean base curve signals the direction/course that the individual's eye condition and its development is on and furthermore indicates the appropriate time interval for that individual to come back for surveillance i.e. screening. If below the mean base curve the individuals' progress is slower than usual and therefore longer period should pass until the next screening. If above the mean base curve the individuals' progress is faster and the screening interval should be shorter. Essentially the individual profile is adjusted in accordance with the mean base curve graph, within the acceptable upper and lower risk limits (see FIG. 3).

In one embodiment, the algorithm developed for both type 1 and type 2 diabetes mellitus is of the general form discussed earlier but solved for time:

$$Par ( t ) = {c}_{1} - ln ( \frac{p}{1 - p} ) + ln ( n + 1 ) * {c}_{2} + Dur * {c}_{3} + A 1 c * {c}_{4} + DBP * {c}_{5}$$

Where:

p is the probability of reaching a treatment end point within Time, ie. 0.01 if the risk is set to 1%
“n” is the number of microaneurysms/hemorrhages within a macula-centered 60 degrees fundus photograph
“Dur” is the patients diabetes duration in years
“Alc” is the individual's haemoglobin Alc in percentage
“DBP” is the diastolic blood pressure in mmHg
c₁ is a constant value preferably between 0-20, more preferably between 4 and 16, most preferably between 5 and 14.
c₂″ is a multiplicative factor for the number of microaneurysms preferably between 0 and 3, more preferably between 0.2-2, most preferably between 0.5-1.2
c₃ is a multiplicative factor for the duration of diabetes preferably between 0 and 1, more preferably between 0.0001-0.1, most preferably between 0.001-0.05
c4 is a multiplicative factor for the haemoglobin Alc preferably between 0 and 3, more preferably between 0.005-2, most preferably between 0.05-0.5
c₅ is a multiplicative factor for the diastolic blood pressure preferably between 0 and 1, more preferably between 0.001-0.2, most preferably between 0.01-0.03. In the special case when c₅=0 the entire third term of the equation goes to zero which is appropriate for the case of diabetes Type 1.

In one embodiment a method for estimating the time interval between visits for health examination comprises the following steps:
providing data for the duration of diabetes;
providing data for haemoglobin Alc;
providing data for blood pressure;
providing data for hemorrhages;
calculating estimated risk based on said data;
providing data for desired probability reaching treatment end point within time;
calculate maximum number of days until next visit for said health examination;
   issue a date for next visit at a date less than said maximum number of days calculated.

In another embodiment, the time duration until next visit to the health clinic is calculated as:

TimeDuration=((A−d)k₁+(B−hbAlc)k₂+(DBP−dbp)k₃+1)k₄

where:
A is a constant in the range from 5 to 25, more preferably in the range from 8 to 22, and most preferably in the range 9 to 21.
B is a constant in the range from 5 to 15, more preferably in the range from 6 to 12, and most preferably in the range from 7 to 11.
DBP is a constant in the range from 60 to 100, more preferably in the range from 70 to 90, and most preferably in the range from 75 to 85.
k₁ is a constant in the range from 0.005 to 0.045, more preferably in the range from 0.01 to 0.04, and most preferably in the range from 0.015 to 0.035.
k₂, is a constant in the range from 0.05 to 0.045, more preferably in the range from 0.1 to 0.4, and most preferably in the range from 0.15 to 0.35.
k₃, is a constant in the range from 0 to 0.035, more preferably in the range from 0.01 to 0.03, and most preferably in the range from 0.015 to 0.025.
k₄ is a constant in the range from 1 to 60, more preferably in the range from 5 to 40, and most preferably in the range 10 to 30.

Constants are determined based on the type of diabetes. In the special case when k₃=0 the entire third term of the equation goes to zero which is appropriate for the case of diabetes Type 1.

The variable d stands for the duration of diabetic condition measured in years and is provided by the user.

The variable hbAlc stands for the persentage of hemoglobin in the blood and is provided by the user.

The variable dbp stands for diastolic blood pressure and is provided by the user in the case of diabetic type 2.

In another embodiment, a mathematical algorithm was created based on epidemiological data on risk factors for diabetic retinopathy from the Icelandic eye screening database. A functional form of the baseline cumulative incidence of sight threatening retinopathy was estimated using the Weibull form of cumulative incidence

F₀(t)=1−S₀(t)=1−exp(−exp(α)t^{β}),

where t is the time from onset of diabetes, S₀(t) is the baseline cumulative survival free of sight threatening retinopathy, and exp( ) is the exponential function. Values of α and β were found separately for diabetes of type 1 and type 2 by fitting F₀(t) to epidemiological data on sight threatening retinopathy in Iceland.

Proportional hazards were assumed to generate personalized estimates of “survival” free from sight threatening retinopathy by exponenting S₀(t) with a linear combination of established risk factors and risk ratios so that the individual survival was S(t)=S₀(t)^{exp(linear combination)}. The risk of developing sight threatening retinopathy in a time interval Δt, given “survival” until time t, was then computed as

1−S(t+Δt)/S(t).

The time duration until next visit to the health clinic is then calculated as:

$$t = ( exp ( \frac{log ( - \frac{log ( 1 - x )}{exp ( {β}_{1} + {RF}_{1} )} + {D}^{{α}_{1}} )}{{α}_{1}} ) - D )$$

were:
x is the risk margin
the constants α₁ and β₁ are found by fitting the Weibull form to epidemiological data from type 1 diabetes
D is the duration in years since diagnozed with diabetes
RF₁=(HbAlc−8)v₅+(sbp−130)v₆, here HbAlc is the hemoglobin and sbp is the systolic blood pressure in mmHg. However, the constant RF₁ can also be estimated as HbAlc*v₅+sbp*v₆+v₁₂.
v₅ is a constant in the range 0 to 0.37, more preferably in the range of 0.09 to 0.28, but most preferably in the range 0.12 to 0.24
v₆ is a constant in the range 0 to 0.015, more preferably in the range of 0.0039 to 0.012, but most preferably in the range 0.055 to 0.01
v₁₂ is a constant in the range 0 to −5, more preferably in the range of −1.25 to −3.75 but most preferably in the range −1.66 to −3.32

For an individual diagnosed type I diabetic and not diagnosed with non-proliferative retinopathy (non-PDR). While for those diagnosed type I diabetic and non-PDR the time duration until next visit to the health clinic is calculated as:

$$t = ( exp ( \frac{log ( - \frac{log ( 1 - x )}{exp ( {β}_{1} - {v}_{1} + {RF}_{1 DR} )} + {D}^{{α}_{1}} )}{{α}_{1}} ) - D )$$

were:
x is the risk margin
the constants α₁ and β₁ are found by fitting the Weibull form to epidemiological data from type 1 diabetes
v₁ is 0.5 log(0.83)
D is the duration in years since diagnosed with diabetes
RF_{1DR}=(HbAlc−8)v₅+(sbp−130)v₆+v₇+sex v₈, here HbAlc is the hemoglobin, sbp is the systolic blood pressure in mmHg, and the constant sex is set to zero for male and one for female. However, the constant RF₁ can also be estimated as HbAlc*v₅+sbp*v₆+v₁₃
v₇ is a constant in the range 0 to 1.04, more preferably in the range of 0.26 to 0.78, but most preferably in the range 0.34 to 0.69
v₈ is a constant in the range 0 to −0.16, more preferably in the range of −0.04 to −0.12, but most preferably in the range −0.05 to −0.1
v₁₃ is a constant in the range 0 to −4.12, more preferably in the range of −1.03 to −3.088, but most preferably in the range −1.37 to −2.75

For individual diagnosed type II diabetic and not diagnosed with non-PDR the time duration until next visit to the health clinic is calculated as:

$$t = exp ( \frac{1}{{α}_{2}} log ( \frac{log ( exp ( \frac{log ( 1 - x )}{exp ( {RF}_{2} )} ) ( exp ( - exp ( {β}_{2} ) {D}^{{α}_{2}} ) - {v}_{2} ) + {v}_{2} )}{- exp ( {β}_{2} )} ) - D )$$

were:
x is the risk margin
the constants α₂ and β₂ are found by fitting the Weibull form to epidemiological data from type 2 diabetes
v₂ is a constant in the range 0 to 1.04, more preferably in the range of 0.26 to 0.78, but most preferably in the range 0.35 to 0.69
D is the duration in years since diagnosed with diabetes
RF₂=(HbAlc−8)v₉+(sbp−130)v₁₀, here HbAlc is the hemoglobin and sbp is the systolic blood pressure in mmHg.
However, the constant RF₁ can also be estimated as HbAlc*v₉+sbp*v₁₀. v₉ is a constant in the range 0 to 0.76, more preferably in the range of 0.19 to 0.57, but most preferably in the range 0.25 to 0.5
v₁₀ is a constant in the range 0 to 0.086, more preferably in the range of 0.022 to 0.065, but most preferably in the range 0.028 to 0.057

While for those diagnosed type II diabetic and non-PDR the time duration until next visit to the health clinic is calculated as:

$$t = exp ( \frac{1}{{α}_{2}} log ( \frac{log ( \begin{matrix}exp ( \frac{log ( 1 - x )}{exp ( {RF}_{2 DR} )} ) \\ ( exp ( - exp ( {β}_{2} - {v}_{3} ) {D}^{{α}_{2}} ) - {v}_{4} ) + {v}_{4}\end{matrix} )}{- exp ( {β}_{2} - {v}_{3} )} ) - D )$$

were:
x is the risk margin
the constants α₂ and β₂ are found by fitting the Weibull form to epidemiological data from type 2 diabetes
v₃ is a constant in the range 0 to −0.27, more preferably in the range of −0067 to −0.2, but most preferably in the range −0.09 to −0.18v₄ is a constant in the range 0 to 0.1, more preferably in the range of 0.26 to 0.078, but most preferably in the range 0.03 to 0.07D is the duration in years since diagnozed with diabetes
RF_{2DR}=(HbAlc−8)v₉+(sbp−130)v₁₀+v₇+sex v₁₁, here HbAlc is the hemoglobin, sbp is the systolic blood pressure in mmHg, and the constant sex is set to zero for male and one for female. However, the constant RF₁ can also be estimated as HbAlc*v₉+sbp*v₁₀+v₁₃.
v₁₁ is a constant in the range 0 to −0.53, more preferably in the range of −0.13 to −0.4, but most preferably in the range −0.18 to −0.35
v₁₃ is a constant in the range 0 to −17, more preferably in the range of −4.2 to −12.6, but most preferably in the range −5.6 to −11.2

### Experiments

The algorithm receives clinical data including type and duration of diabetes, HbAlC or average blood sugar, average blood pressure and the presence and grade of retinopathy (FIG. 2). These data are used to calculate risk for sight threatening retinopathy for each individual's worse eye over a given time span. An acceptable risk level is defined and the algorithm recommends the screening interval for each patient, i.e. when (s)he should be seen next time in the screening clinic.

The database for diabetic retinopathy at the Department of Ophthalmology, Aarhus University Hospital, Denmark, was used to test the safety and efficiency of the algorithm. The database is described in detail by Mehlsen et al (Mehlsen et al., 2010; 2009). Prospectively accumulated clinical data, fundus photographs and information on outcome are available for 5210 patients over up to 20 years and this allows testing the algorithm in a prospective manner. We asked the question: If our algorithm had been used for this cohort for 20 years, what would have been the mean screening interval and how many patients would have developed sight threatening retinopathy within the prescribed interval. Our algorithm was compared to the outcome from fixed 12 month screening interval for all. For the experiment, the values of the constants was selected as follows: v₁=0.5 log(0.83), v₂=0.52, v₃=0.5 log(0.54), v₄ is 0.052, v₅=0.1851, v₆=0.007813, v₇=log(3.3), v₈=log(0.83), v₉=0.380544, v₁₀=0.04308, v₁₁=log(0.54).

### Results:

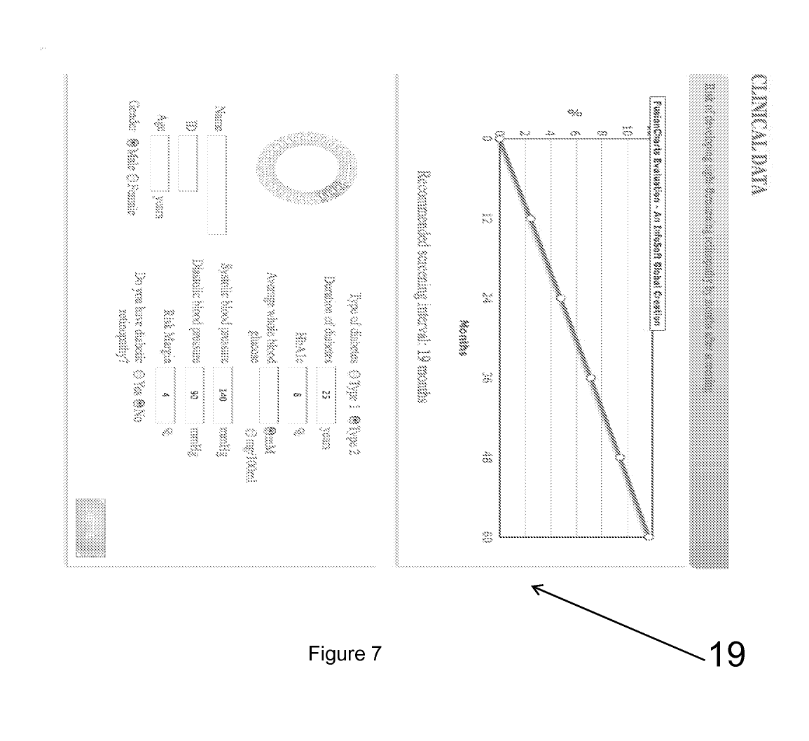

FIG. 7 shows a computer screen shot and an example of how the algorithm would be used for an individual patient. The patient's clinical data has been entered in the panel and the graph shows this patient's risk of developing sight threatening retinopathy over time. As the risk level had been set at 4%, the algorithm recommends that this patient be screened again, when his risk level reaches 4%, which happens to be 20 months in this case, as is shown in on the computer screen 19.

The following table shows the results from testing the algorithm in the Aarhus diabetic data base. The acceptable risk level is set by the user.

| | Risk Level | | | | | |
|---|---|---|---|---|---|---|
| | 0.50% | 1% | 2% | 4% | 6% | 10% |
| Average | 8 | 11 | 17 | 26 | 33 | 40 |
| screening | | | | | | |
| interval in | | | | | | |
| months | | | | | | |
| Cost | 49% | 7% | −30% | −55% | −64% | −70% |
| comparison | | | | | | |
| to fixed 12 | | | | | | |
| month | | | | | | |
| screening | | | | | | |
| STR | 3 | 12 | 32 | 95 | 144 | 208 |
| Individuals | | | | | | |
| Safety | 98% | 92% | 79% | 36% | 3% | −40% |
| Improvement | | | | | | |

The mean recommended screening interval ranges from 8-40 months for the 0.5-10% risk levels shown. Considering the 4% risk level, as this may be clinically optimal, the algorithm recommends a mean of 26 months screening intervals.

In the table the reduction in screening visits and costs are compared with fixed 12 month screening intervals. The reduction in screening frequency and cost is shown in percent compared with fixed annual screening. If the 4% risk level is selected, the algorithm recommends 55% fewer visits than with regular annual visits.

As a measure of safety, the number of individuals, who develop sight threatening retinopathy within the recommended screening interval, is compared between our algorithm and the fixed annual screening approach. The table shows the improvement in safety in percent. With the 4% risk level 95 patients would develop sight-threatening retinopathy within the recommended screening interval compared to 149 with fixed annual visits. This represents a 36% improvement in safety. Clearly, the user can receive different levels of safety and cost savings by varying the risk level.

1-16. (canceled)

17. A method for individualized allocation of health resources, for individuals already diagnosed with diabetes, said method comprising the steps of:
measuring a risk factor for said individual, wherein said risk factor is measured as a linear combination of hemoglobin HbAlc and systolic blood pressure substantially HbAlc*K1+sbp*K2, wherein K1, and K2 are scaling factors;
receiving data for a desired risk margin, said risk margin being substantially 4%; and
measuring a time duration until a next screening based on said risk margin and said risk factor.

18. The method according to claim 17, wherein said scaling factor K1 is a parameter substantially in the range of 0.1 to 0.5.

19. The method according to claim 17, wherein said scaling factor K1 is a parameter substantially in the range of 0.11 to 0.45.

20. The method according to claim 17, wherein said scaling factor K1 is a parameter substantially in the range of 0.15 to 0.4.

21. The method according to claim 17, wherein said scaling factor K2 is a parameter substantially in the range of 0.001 to 0.1.

22. The method according to claim 17, wherein said scaling factor K2 is a parameter substantially in the range of 0.003 to 0.08.

23. The method according to claim 17, wherein said scaling factor K2 is a parameter substantially in the range of 0.005 to 0.06.

24. The method according to claim 17, wherein said risk factor comprises an additional additive term, said additive term being a parameter substantially in the range of −1.0 to 1.5.

25. The method according to claim 17, wherein said risk factor comprises an additional additive term, said additive term being a parameter substantially in the range of −0.75 to 1.25.

26. The method according to claim 17, wherein said risk factor comprises an additional additive term, said additive term being a parameter substantially in the range of −0.5 to −1.0.

27. The method according to claim 17, wherein said risk margin is in the range of 0.05% to 10%.

28. A computer program or suite of computer programs embodied on a non-transitory computer readable medium, and so arranged such that when executed on a processor said program or suite of programs cause(s) said processor to perform the method of claim 17.

29. A non-transitory computer readable data storage medium storing the computer program or at least one of the suites of computer programs of claim 28.

30. A non-transitory computer program product according to claim 28, wherein a database resides on the same computer as said computer program product.

31. A non-transitory computer program product according to claim 28, wherein a database, and said computer program product reside on different computers.

32. A system for individualized allocation of health resources for already diagnosed individuals, said system comprising:
a processor;
a human machine interface further comprising:
means for receiving data; and
means for communicating information;
data storage; and
a computer program or suite of computer programs according to claim 28;
wherein said system is adapted to receive data for a desired risk margin, said risk margin being substantially 4%, and said processor executes said computer program or suites of computer programs to measure a time duration until a next screening based on said risk margin and said risk factor.
